(19) United States
(12) Patent Application Publication
(10) Pub. No.: US 2003/0131597 A1
(43) Pub. Date: Jul. 17, 2003

(54) Shore-based ocean thermal gradient hydraulic power plant

(76) Inventor: Earl J. Beck, Oak View, CA (US)

Correspondence Address: Earl J. Beck, 125 Feliz Drive, Oak View, CA, 93022, US

(21) Appl. No.: 10/046,047

(22) Filed: Jan. 15, 2002

(51) Int. Cl. F03G 7/04; F03G 7/06

(52) U.S. Cl. 60/641.6; 60/641.7

(57) ABSTRACT

The present patent introduces an alternative construction to my concept of an Ocean Thermal Gradient Hydraulic Power Plant (OTGHPP), U.S. Pat. No. 6,202,417 of Mar. 20, 2001, in the form of an intake pump furnishing sea water to the intake nozzle of the Steam Lift Pump (SLP) under sufficient volume and pressure to achieve an optimum flow and working head on the OTGHPP's hydraulic turbine without deep immersion of the nozzle, as normally would be useful for plants sited in deep water.

### BACKGROUND OF THE INVENTION

Former U.S. Pat. Nos. 3,967,449 and 6,202,417 (Beck '76 and Beck'01) which describe conceptually and in detail respectively the “Ocean Thermal Gradient Hydraulic Power Plant” (OTGHPP) anticipate the placement of such power plants some distance from shore, in deep water with warm surface waters and deep cold waters. Such plants generally require a maximum difference in temperature between the warm and cold waters, to achieve a maximum thermal efficiency as understood by the well-known concept of efficiency as revealed by the 19^{th} Century French physicist, Sadi Carnot. The two types of plants most studied, the Open and Closed cycles, based on the Rankine power cycle both require large amounts of cold as well as warm water, and the water must be as cold as practicable.

Because the OTGHPP does not operate on the Rankine Cycle, it does not need extremely cold water in the process of quenching the steam in its bubbles, sufficiently cold water may be obtained many places in the world fairly near shore and at shallow depths, especially near tropical islands. It may not be practicable to immerse the inlet nozzle of the Steam Lift Pump (SLP) of the OTGHPP to a sufficient depth to be useful. As the main function of deep immersion is to produce a high presssure at the nozzle's intake, the proposed alternative to deep immersion introduced here is to use an intake pump to produce the flow and pressure at the nozzle's intake. While the intake pump takes useful power, that is off-set by an increased working head to the system's hydraulic turbine, as will be appreciated from the following discussion.

The use of an intake pump to produce the high head desirable for producing power allows the siting of OTGHPP's at or near the ocean's shore, allowing fixed (as compared with floating, moored plants) with the advantages of on-shore location and without the complications of mooring, sea-keeping, excessive maintenance of a floating platform against corrosion, wave action, long underwater power cables to shore, etc.

1. Field of the Invention

The present invention relates to an improved method for the design of an Ocean Thermal Gradient Hydraulic Power plant as described in Beck '01), so that it may be located on or near shore in shallow water, and still provide a method of obtaining a useful pump height. It further shows how to obtain maximum pump heights, taking advantage of the stability of very tall structures that may be used on large structures affixed to the ocean's floor or on-shore structures with stable foundations obtainable on shore, as compared with floating systems in deep water.

2. Description of the Prior Art

Prior art is well illustrated by my two earlier patents, Beck '76 and Beck '01. To secure sufficient pressure of the intake nozzle of the Steam Lift Pump (SLP) and at the same time a platform from which to pump deep cold water, it was anticipated that systems would normally be moored in deep water. However, the first documented large-scale model of an Ocean Thermal Energy Conversion (OTEC) plant as used by Georges Claude was on-shore in Cuba. Later experiments were constructed at sea to avoid the problems in working in the littoral zone. The most recent experiments, conducted by the Department of Energy with the financial cooperation of the State of Hawaii and Japan, were conducted on shore on the island of Hawaii, with both warm and cold water intakes traversing the littoral zone submerged in rock. Both Claude's and the DoE's experiments were of the “Open Cycle” type, requiring large amounts of both warm and cold water, as dictated by the 2^{nd} Law of Thermodynamics. The thermodynamic cycle is that widely known as the “Rankine Cycle”, which needs large amounts of the coldest possible condensing water.

### SUMMARY OF THE INVENTION

The present invention summarizes the changes to be made to my earlier designs as shown in my earlier patents that allow the location of the OTGHPP's on shore or near shore on bottom mounted fixed platforms, while still developing the high heads on the system's hydraulic turbines as necessary to generate large amounts of power without taking suction on the SLP from great depths as might be useful in moored systems in deep water, as contemplated in my two earlier patents. Briefly the alternative construction revealed here anticipates developing the required pressure in the bottom of the Steam Lift Pump (SLP) using a suitable hydraulic pump, driven with power taken from the shaft mounting the hydraulic turbine. An alternative arrangement might use power driven from the hydraulic turbine's shaft transferring power to a separate shaft driving the hydraulic pump. This alternative arrangement is not shown for brevity, as being well established in the engineering art. Power might be transmitted between the two shafts in a number of ways, including geared drives or an electric motor, or even belting if desired.

### A BRIEF DESCRIPTION OF THE DRAWINGS

FIG. 1 is FIG. 1 of my recent patent (Beck, 2001), showing the original concept which used a deep-water intake at depth S to provide the pressure necessary for the SLP.

FIG. 1 is a revised partial FIG. 1, showing a SLP tube taking suction from an annular distribution duct feeding a plethora of SLP's, which in turn is fed with sea water from a centrifugal pump taking suction from just sufficient depth to insure a net positive suction head (NPSH), as is universally accepted good hydraulic design. All parts are identified in the drawings here with the same numbers and symbols as were used

FIG. 2 shows an on-shore plant in plan view, with warm water intake in an excavated pit protected by a sea wall.

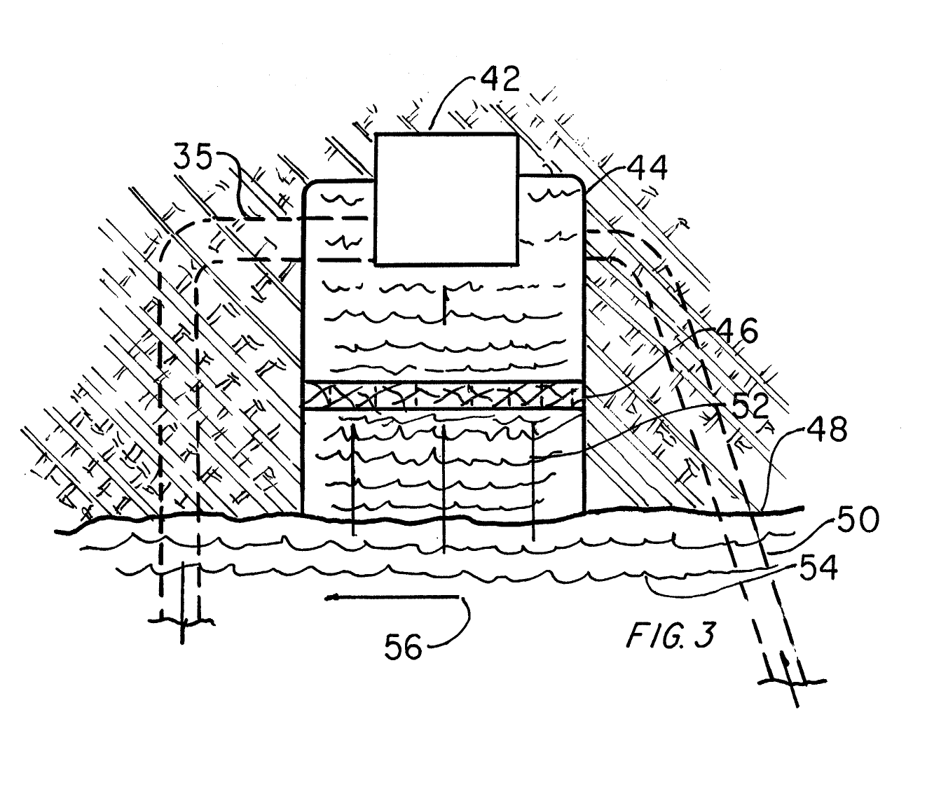

An off-shore installation on a structural steel platform such as are used in off-shore drilling is not shown for brevity, and would have similar components as in FIG. 2, but with no excavated pit or sea-wall. Such an installation would use the several legs of the platform for ducts for water as needed.

### DETAILED DISCUSSION OF THE INVENTION

In the following discussion, all aspects and parts of the Ocean Thermal Gradient as shown in my March 2001 patent of the same name not addressed here are unchanged.

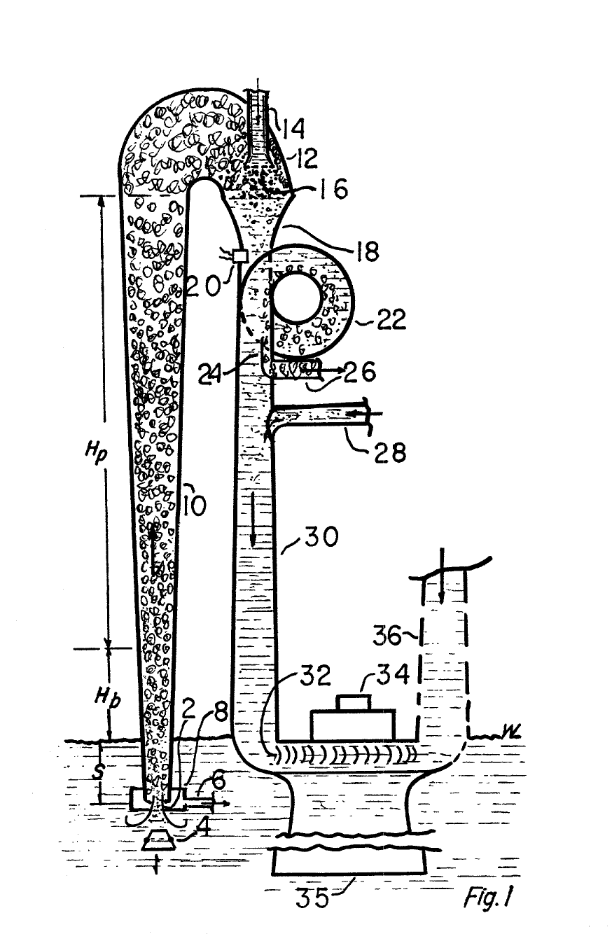

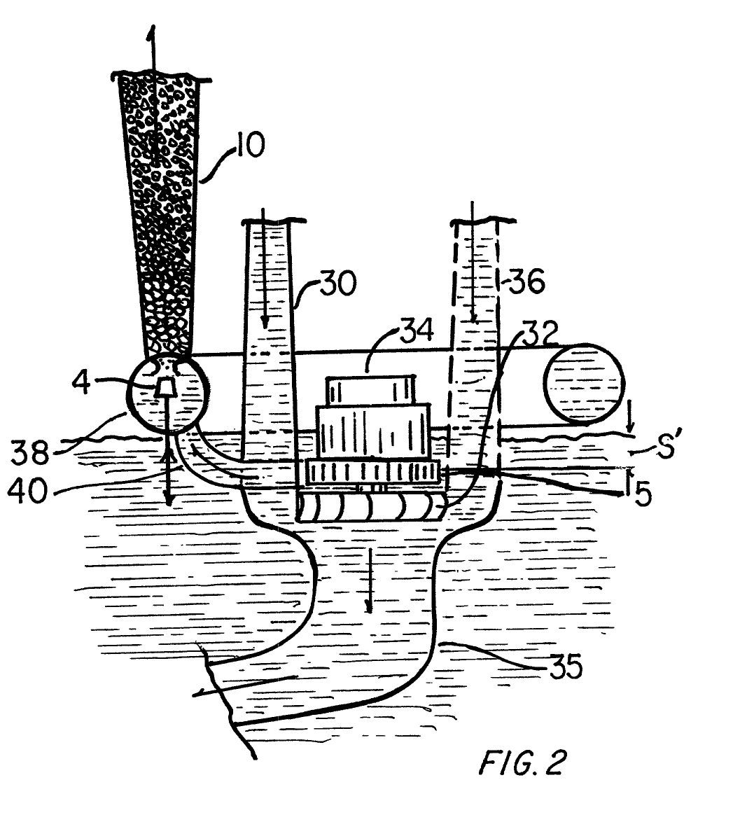

FIG. 1 is FIG. 1 of my 2001 patent, with a deep warm water intake, S, which provides the SLP 10 with sufficient pressure at its intake 2 to support the column of foam in 10 to the desired, useful height to allow the production of power.

FIG. 2 shows a much decreased submergence S′ of the new component, a warm water pump 5 driven as shown here by the same shaft driving the electrical generator 34. The pump 5's depth of intake S′ may be just sufficient to insure a net positive suction head (NPSH) as dictated by good hydraulic design. As shown, pump 5 is mounted on and driven by the same shaft that transmits power from the hydraulic turbine 32 to the electrical generator 34 but may be mounted in a different area and driven by any of suitable conventional means such as belts, geared shafts, belts, etc. In the new configuration in which instead of large submergence (S in FIG. 1) to produce a high pressure on the SLPs' 10 intake nozzle 2, the warm water pump 5 provides the necessary flow and pressure at the SLPs' intakes. The pump 5 sends warm sea water through a duct 40 to an annular duct 38 from which the many SLP's take water under pressure as provided by the pump 5. The starting valves 4 as shown in FIGS. 1 and 2 as well as the toridal distribution duct 38 may conveniently be located above water and so become easily accessible, in contrast to the original arrangement in which these parts may be submerged at some depth, S in FIG. 1 Not shown in FIG. 2 for simplicity is the de-watering ducts 6 as shown in FIGS. 1 and 2 Beck '01, which would be incorporated into the distribution duct 38. Similarly omitted for simplicity in this figure are the fast-acting hydraulic or pneumatic pistons 44 for starting the individual SLP's 10. As shown in FIGS. 1 and 2 of Beck '01. The slightly cooled sea water exits the hydraulic turbine 32 to the appropriate level in the ocean through duct 35 which may be through an excavated tunnel in on-shore installation as shown in the next figure or through the legs of an off-shore platform, not shown.

FIG. 3 shows a plan view of an OTGHPP 42 mounted over an excavated pit 44 through which the warm surface water flows by gravity to the intake of the pump 5 in FIG. 2. The OTGHPP is protected from the breaking ocean waves by a protective wall 46 with submerged openings, not shown in detail, to allow the water to pass through to the pit 44. The hydraulic turbine's discharge duct 35 is shown as an excavated duct discharging down-stream in the littoral flow at an appropriate depth. A similar the cold water condensing water delivery tube 50, takes suction from sufficiently deep cold water from the ocean 54 to achieve quenching of the bubbles in the SLP (10) tubes and the condensation of the steam therein. The cold water intake duct 50 and the discharge duct 35 are positioned upstream and downstream respectively of the littoral drift 56 to avoid re-circulation that might warm the cold condensing water delivered through 50.

What I claim is:

1. In the steam lift pump of an Ocean Thermal Gradient Hydraulic Power Plant, in which pressure on its intake is heretofore accomplished by immersing it at depth, the substitution of an hydraulic pump to provide the pressure necessary to support a tall column of foam.
(a) Elimination of the deep water submergence of the intakes of the steam lift pumps which provide pressure to the SLP's, and taking suction from near the surface of the ocean.
(b) Replacement of the deep submergence intakes with a centrifugal pump delivering warm surface water to the intakes of a plethora of SLP's receiving the warm water through a toroidal duct from which the SLP's take suction.
(c) Incorporation of the starting valves for the SLP's into said toroidal duct from which the SLP's take suction, and.
(d) Utilization of the platforms legs as cold water intake and turbine discharge ducts or in the case of on-shore applications of subterranean tunnels to at least below the surf zones in the cases of the cold water intake and turbine discharge ducts in on-shore installations.
